(19) United States
(12) Patent Application Publication
(10) Pub. No.: US 2017/0340503 A1
(43) Pub. Date: Nov. 30, 2017

(54) ORTHOPEDIC REHABILITATION DEVICE

(71) Applicant: Aaron Turner, Warsaw, IN (US)

(72) Inventor: Aaron Turner, Warsaw, IN (US)

(21) Appl. No.: 15/168,905

(22) Filed: May 31, 2016

(51) Int. Cl. A61H 1/02; A63B 23/035; A63B 23/00

(52) U.S. Cl. CPC A61H 1/0237; A63B 23/0355; A61H 2205/102; A63B 2023/006

(57) ABSTRACT

An orthopedic rehabilitation device is provided having a base assembly. A mast assembly extends from the base assembly. A handle assembly is rotatably coupled to the mast assembly. A foot bracket assembly is rotatably coupled to the mast assembly. The foot bracket assembly is coupled to the handle assembly so that rotation of one of the handle assembly or the foot bracket assembly results in the rotation of the other of the handle assembly and the foot bracket assembly. A foot support assembly is coupled to the foot bracket assembly so that the foot support assembly rotates with the foot bracket assembly.

### BACKGROUND OF THE DISCLOSED EMBODIMENTS

Generally, individuals with an injured knee and/or post-operative knee require management of knee pain through therapeutic exercises to rehabilitate soft tissue injuries and degenerative joint conditions, restore joint range of motion, restore strength, and modulate pain to increase limb function both pre- and post-operatively. Often, individuals who are post-surgery, following a traumatic knee injury, or having a degenerative joint condition, may experience loss of range of motion and knee function due to pain and immobility. For example, individuals with chronic knee pain from degenerative joint disease who have undergone surgery for anterior or posterior cruciate ligament reconstructions, torn meniscus, femoral and tibia plateau fractures, knee replacements, or other injuries associated with the knee joint or nearby areas of the body often experience some degree of arthrofibrosis (joint stiffness), which causes pain and limited joint range of motion that limits overall functional independence and quality of life. Arthrofibrosis is one of the leading complications of knee surgery and a cause in knee stiffness and pain. Arthrofibrosis may involve the loss of flexion, extension, and rotational movements in the knee and subsequently loss of muscle strength and flexibility. Arthrofibrosis may also be a cause for revision surgery and/or joint manipulation to reestablish normal joint range of motion and function of the knee.

A need remains for a rehabilitation device that improves flexion and extension of the knee.

### SUMMARY OF THE DISCLOSED EMBODIMENTS

In one aspect, an orthopedic rehabilitation device is provided having a base assembly. A mast assembly extends from the base assembly. A handle assembly is rotatably coupled to the mast assembly. A foot bracket assembly is rotatably coupled to the mast assembly. The foot bracket assembly is coupled to the handle assembly so that rotation of one of the handle assembly or the foot bracket assembly results in the rotation of the other of the handle assembly and the foot bracket assembly. A foot support assembly is coupled to the foot bracket assembly so that the foot support assembly rotates with the foot bracket assembly.

In one aspect, an orthopedic rehabilitation device is provided including a base assembly having a plate to support the device and a base mast extending substantially perpendicular from the plate. A mast assembly adjustably extends from the base mast so that a height of the mast assembly may be adjusted. A handle assembly rotatably couples to the mast assembly proximate to the base assembly. A foot bracket assembly rotatably couples to the mast assembly distally from the base. At least one rotational bracket couples the foot bracket assembly and the handle assembly so that rotation of one of the handle assembly or the foot bracket assembly results in the rotation of the other of the handle assembly and the foot bracket assembly. A foot support assembly is coupled to the foot bracket assembly so that the foot support assembly rotates with the foot bracket assembly. The foot support assembly includes a foot support for placing a foot of a user.

In one aspect, a method for constructing an orthopedic rehabilitation device is provided. The method includes extending a mast assembly from a base assembly. The method includes rotatably coupling a handle assembly to the mast assembly. The method includes rotatably coupling a foot bracket assembly to the mast assembly. The method includes coupling the foot bracket assembly to the handle assembly so that rotation of one of the handle assembly or the foot bracket assembly results in the rotation of the other of the handle assembly and the foot bracket assembly. The method includes coupling a foot support assembly to the foot bracket assembly so that the foot support assembly rotates with the foot bracket assembly.

### BRIEF DESCRIPTION OF DRAWINGS

The embodiments described herein and other features, advantages and disclosures contained herein, and the manner of attaining them, will become apparent and the present disclosure will be better understood by reference to the following description of various exemplary embodiments of the present disclosure taken in conjunction with the accompanying drawing, wherein:

FIG. 1 is a top perspective view of an orthopedic rehabilitation device in an extended position in accordance with an embodiment.

FIG. 2 is a top perspective of the orthopedic rehabilitation device shown in FIG. 1 in a flexed position.

FIG. 3 is a top perspective view of a base assembly in an operation position in accordance with an embodiment.

FIG. 4 is a top perspective view of a base assembly in a storage position in accordance with an embodiment.

FIG. 5 is a side perspective view of a leg support in accordance with an embodiment.

FIG. 6 is a side perspective view of a mast assembly in accordance with an embodiment.

FIG. 7 is a side perspective view of a handle assembly in accordance with an embodiment.

FIG. 8 is a side perspective view of a foot bracket assembly in accordance with an embodiment.

FIG. 9 is a top perspective view of a foot support in accordance with an embodiment.

FIG. 10 is a side view of a rotational bracket formed in accordance with an embodiment.

FIG. 11 is a side view of a rotational bracket formed in accordance with an embodiment.

FIG. 12 is a top perspective view of the orthopedic rehabilitation device shown in FIG. 1 having a person thereon.

FIG. 13 is a top perspective view of the orthopedic rehabilitation device shown in FIG. 1 configured for a left foot.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

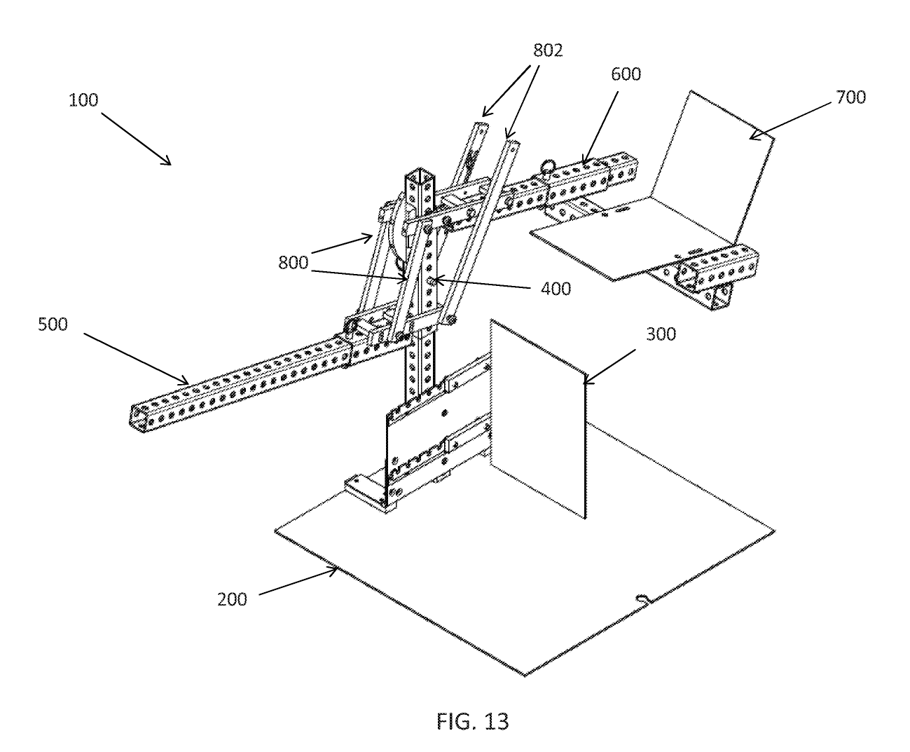

The embodiments described herein provide an orthopedic rehabilitation device 100. The device 100 may be utilized for flexion and/or extension of a knee. Although the embodiments described herein are described with respect to flexion and/or extension of the knee, it will be appreciated that the embodiments described herein may be utilized to address the movement of other joints. The illustrated embodiments show the device 100 as arranged for use with the right leg of a user. It will be appreciated that the device 100 may also be utilized with the left leg of a user by rearranging some parts, as illustrated in FIG. 13.

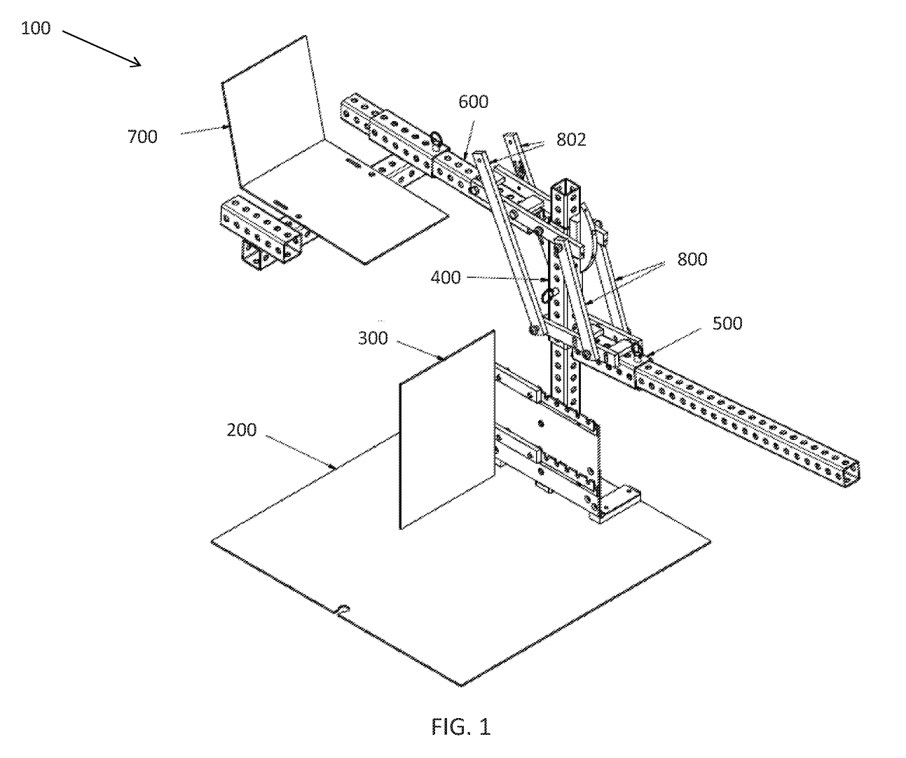

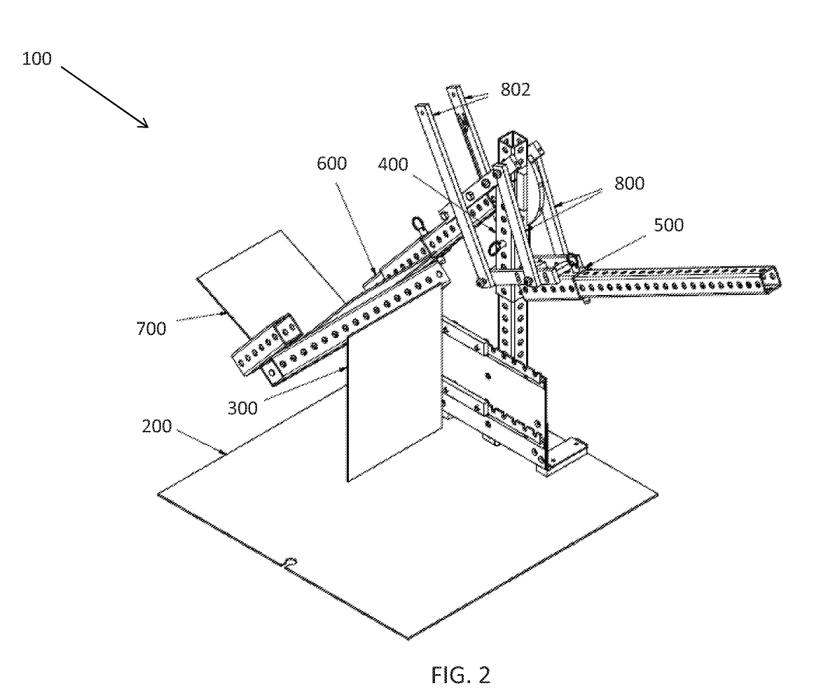

FIG. 1 shows the device 100 in an extended position. FIG. 2 shows the device 100 in a flexed position. The device 100 includes a base assembly 200 for supporting the device 100. For example, the base assembly 200 may prevent the device 100 from tipping over during use. The base assembly 200 includes a leg support assembly 300 that supports the leg of a user. A mast assembly 400 extends from the base assembly 200. In one embodiment, the mast assembly 400 is adjustably coupled to the base assembly 200, as described in detail below. The mast assembly 400 may be adjustably coupled to the base assembly 200 to adjust a height of the mast assembly 400 to accommodate a size of the user. That mast assembly 400 is illustrated as being coupled to the base assembly 200 for use with a right leg.

A handle assembly 500 is rotatably coupled to the mast assembly 400. In one embodiment, the handle assembly 500 is coupled to the mast assembly 400 proximate to the base assembly 200. The handle assembly 500 may be adjustable in length to accommodate the size of the user. A foot bracket assembly 600 is also rotatably coupled to the mast assembly 400. In one embodiment, the foot bracket assembly 600 is coupled to the mast assembly 400 distally from the base assembly 200. The foot bracket assembly 600 is rotatably coupled to the handle assembly 500 (as described in more detail below) by rotational brackets 800 and 802. The rotational brackets 800 and 802 enable the handle assembly 500 and the foot bracket assembly 600 to move simultaneously. The handle assembly 500 provides a handle for the user to move and control the foot bracket assembly 600. For example, movement of the handle assembly 500 moves the foot bracket assembly 600 to facilitate movement of the user's knee joint. Also, the foot bracket assembly 600 may be allowed to move through the force of gravity, thereby facilitating movement of the user's knee joint. In such a scenario, the handle assembly 500 may be utilized to control the speed of movement of the foot bracket assembly 600.

A foot support assembly 700 is coupled to the foot bracket assembly 600. In one embodiment, the foot support assembly 700 is adjustably coupled to the foot bracket assembly 600 to adjust a distance between the foot support assembly 700 and the mast assembly 400. The foot support assembly 700 may be adjusted to accommodate a length of a user's leg. The foot support assembly 700 is configured to provide a position for the user to place their foot while using the device 100.

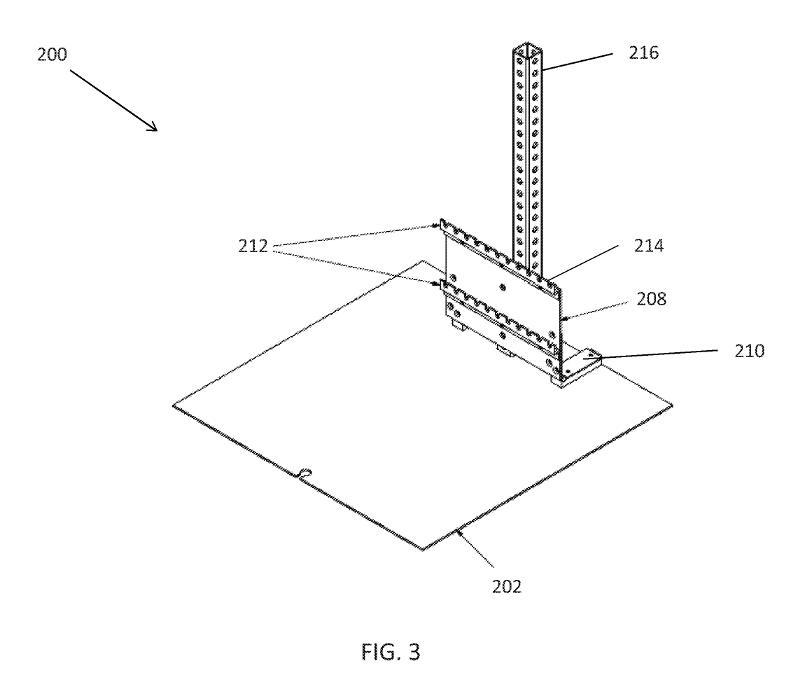

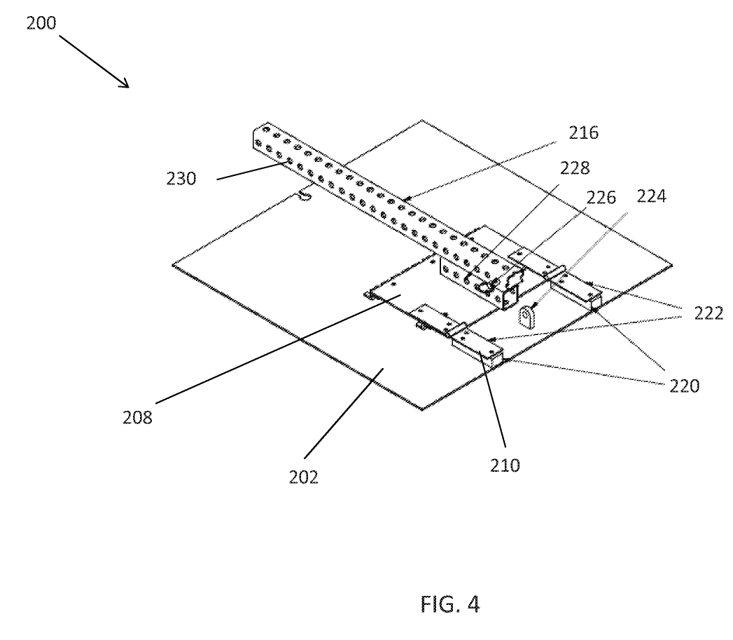

FIGS. 3-4 illustrate the base assembly 200. FIG. 3 illustrates the base assembly 200 in an operational position, wherein a user may flex and/or extend their knee with the device 100. FIG. 4 illustrates the base assembly 200 in a storage position. The base assembly 200 includes a plate 202 to support the device 100. In one embodiment, the plate 202 may be weighted for additional stability. A leg support base 208 is coupled to the plate 202. In the illustrated embodiment, the leg support base 208 is coupled to a side of the plate 202. In one embodiment, the leg support base 208 is coupled at any position on the plate 202. In one embodiment, the leg support base 208 is coupled to the plate 202 with a coupling mechanism 210. The coupling mechanism 210 may include a hinge 222 and a riser 220 positioned between the hinge 222 and the plate 202. The riser 220 lifts the leg support base 208 from the plate 202 so that the leg support base 208 may rotate between the storage position and the operational position via the hinge 222. In the operational position, the leg support base 208 is arranged substantially perpendicular to the plate 202. In the storage position, the leg support base 208 is arranged substantially parallel to the plate 202.

The leg support base 208 includes at least one leg support rail 212 coupled thereto. The illustrated embodiment includes two leg support rails 212. In various embodiments, any number of leg support rails 212 may be utilized. Each leg support rail 212 includes a plurality of notches 214. The notches 214 are configured to receive the leg support assembly 300, as described below.

A base mast 216 is coupled to the leg support base 208. In one embodiment, the base mast 216 is coupled to a side of the leg support base 208 that is opposite a side to which the leg support rail 212 is attached. The base mast 216 is configured to rotate between the operational position and the storage position with the leg support base 208. In the operational position, the base mast 216 is arranged substantially perpendicular to the plate 202. In the storage position, the base mast 216 is arranged substantially parallel to the plate 202. A spacer 228 may be provided between the base mast 216 and the leg support base 208 to provide space for the device 100 to collapse into a storage position, as illustrated in FIG. 4. The base mast 216 includes a plurality of openings 230 extending therethrough.

In one embodiment, the base assembly 200 includes a post 224. The post 224 is positioned such that the base mast 216 fits over the post 224 when the base mast 216 is moved into the operational position. When the base mast 216 is fit over the post 224, one of the openings 230 in the base mast 216 aligns with an opening in the post 224. A locking mechanism 226, for example a pin, may then be inserted into the opening 230 of the base mast 216 and through the opening in the post 224 to retain the device 100 in the operational position. The locking mechanism 226 may be removed, to configure the device 100 in the storage position. It should be appreciated that any locking mechanism may be utilized to retain the device 100 in the operational position.

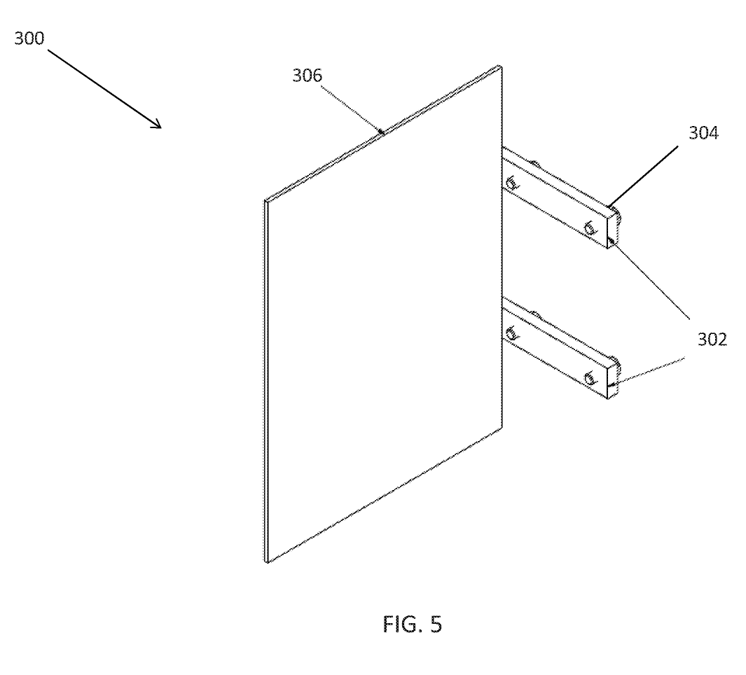

FIG. 5 illustrates the leg support assembly 300. The leg support assembly 300 includes a pin assembly 302. In the illustrated embodiment, the leg support assembly 300 includes two pin assemblies 302. The number of pin assemblies 302 is configured to be the same as the number of leg support rails 212. Each pin assembly 302 includes at least one pin 304. The pins 304 are configured to be received in any one of the notches 214 formed in the leg support rails 212 to retain the leg support assembly 300 in position. A leg support 306 is coupled to the pin assemblies 302 to provide a position for the user to place their upper leg. By positioning the pins 304 in different notches 214 a distance of the leg support 306 from the mast assembly 400 may be adjusted to accommodate the size of the user.

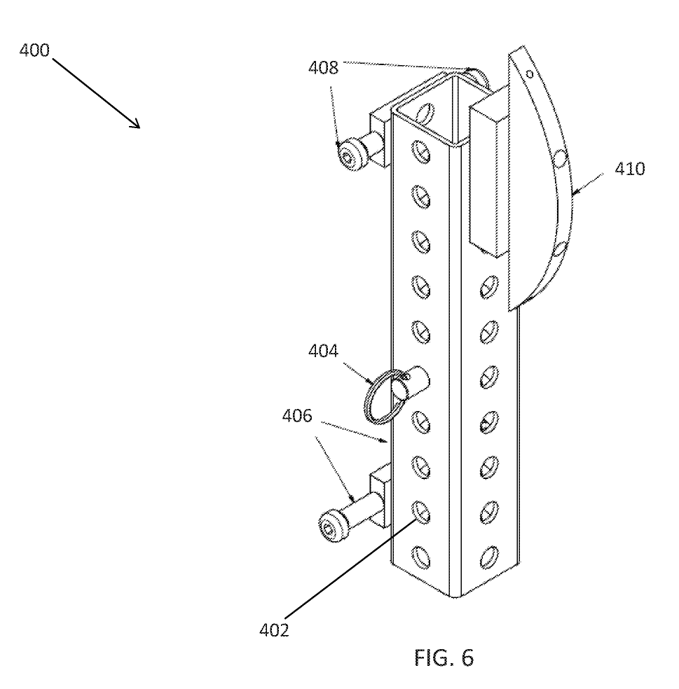

FIG. 6 illustrates the mast assembly 400. The mast assembly 400 is configured to be positioned over the base mast 216 so that the mast assembly 400 and the base mast 216 are coupled in a telescoping arrangement. The mast assembly 400 is adjustable with respect to the base mast 216 to adjust a height of the mast assembly 400 with respect to the base assembly 200 to accommodate a size of the user. The mast assembly 400 includes a plurality of openings 402 extending therethrough. To couple the mast assembly 400 to the base mast 216, at least one of the openings 402 is aligned with an opening 230 on the base mast 216. A locking mechanism 404, for example a pin, may then be inserted through both the opening 402 and the opening 230 to lock the mast assembly 400 to the base mast 216. It will be appreciated that any locking mechanism may be utilized to lock the mast assembly 400 to the base mast 216.

The mast assembly 400 includes a lower post 406 and an upper post 408. The lower post 406 is configured to couple to the rotational bracket 802 to accommodate movement of the handle assembly 500 and the foot bracket assembly 600. In particular, the rotational bracket 802 rotates with respect to the lower post 406 to accommodate movement of the handle assembly 500 and the foot bracket assembly 600.

A scale 410 may be provided on the mast assembly 400. The scale 410 may indicate an angle at which a user's knee is bent during operation of the device 100. Accordingly, the user can track the progress of knee flexion and/or extension.

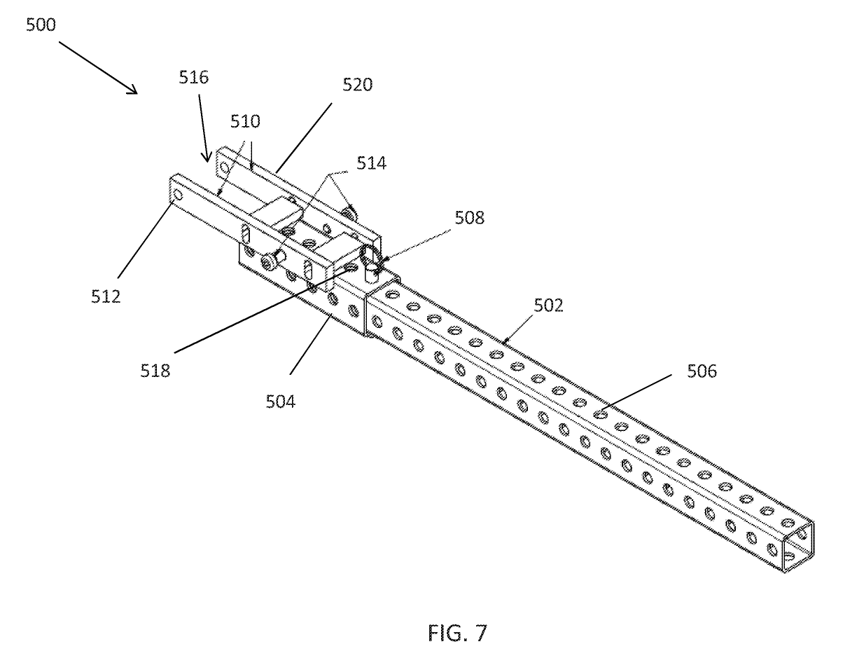

FIG. 7 illustrates the handle assembly 500. The handle assembly 500 includes an outer post 504 and a handle 502. In one embodiment, the handle 502 operates as a handle for the device 100. The outer post 504 includes openings 518 and the handle 502 includes openings 506. The handle 502 is adjustably and telescopically inserted into the outer post 504. A position of the handle 502 within the outer post 504 may be adjusted to adjust a length of the handle assembly 500. An opening 506 of the handle 502 is aligned with and opening 518 of the outer post 504 so that a locking mechanism 508, for example a pin, may be inserted through the opening 506 and the opening 518 to retain the handle 502 within the outer post 504. It will be appreciated that any locking mechanism may be utilized to lock the handle 502 within the outer post 504.

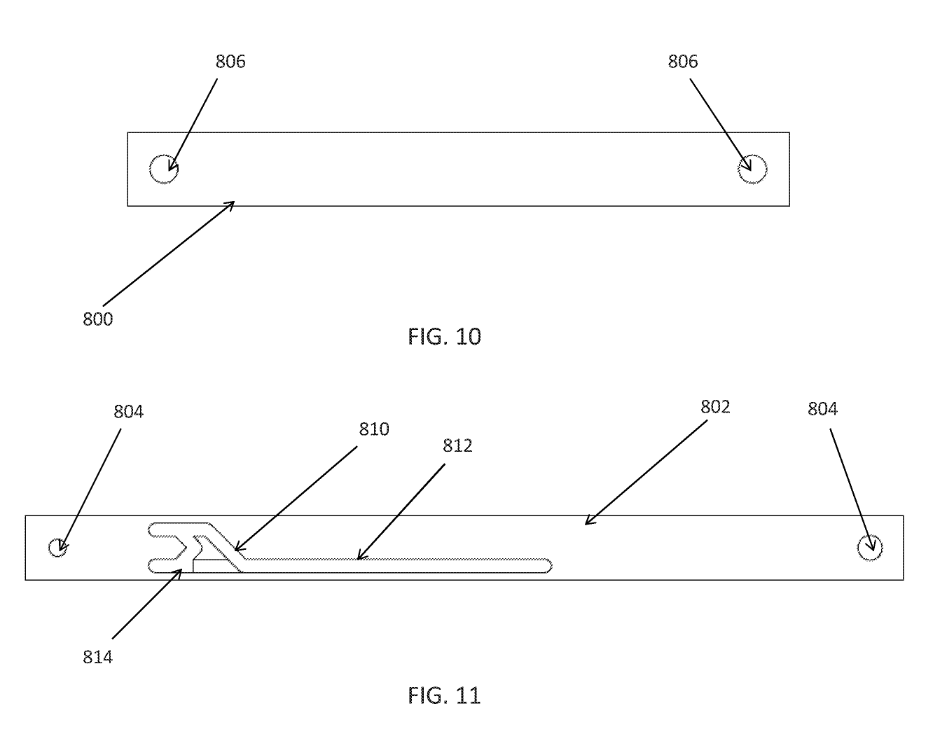

A handle assembly bracket 510 is coupled to the outer post 504. The handle assembly bracket 510 includes a pair of arms 520 defining a space 516 therebetween. The handle assembly bracket 510 includes handle posts 514 and openings 512 on each arm 520. The handle assembly 500 is coupled to the mast assembly 400 so that the mast assembly 400 is received within the space 516 with the arms 520 of the handle assembly bracket 510 on opposite sides of the mast assembly 400. The openings 512 are received on the lower posts 406 of the mast assembly 400. In the illustrated embodiment, the lower posts 406 of the mast assembly 400 receive both the arms 520 of the handle assembly bracket 510, via the openings 512, and the rotational bracket 802, via the openings 804 in the rotational bracket 802, as shown in FIG. 11. Accordingly, the lower posts 406 accommodate rotation of both the rotational bracket 802 and the handle assembly 500. The handle posts 514 are configured to couple to the rotational bracket 800, via the openings 806 in the rotational bracket 800, as shown in FIG. 10, to further facilitate rotation of the handle assembly 500.

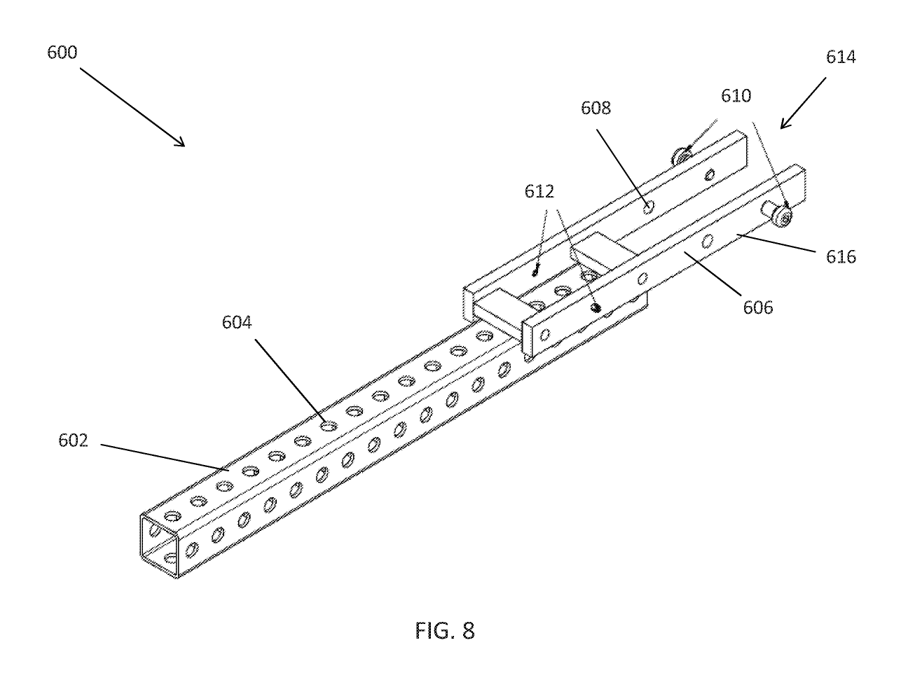

FIG. 8 illustrates the foot bracket assembly 600. The foot bracket assembly 600 includes a post 602 having a plurality of openings 604. A foot bracket assembly bracket 606 is coupled to the post 602. The foot bracket assembly bracket 606 includes a pair of arms 616 defining a space 614. A bracket post 610 is provided on each arm 616. Additionally, an opening 608 and a pin 612 is provided on each arm 616. The foot bracket assembly 600 is coupled to the mast assembly 400 so that the mast assembly 400 is received within the space 614 with the arms 616 of the foot bracket assembly bracket 606 positioned on opposite sides of the mast assembly 400.

The openings 608 are coupled to the upper posts 408 of the mast assembly 400 and allowed to rotate with respect thereto. The bracket posts 610 are coupled to the rotational bracket 800, via the openings 808 in the rotational bracket 800, as shown in FIG. 10, and allowed to rotate with respect thereto. Additionally, pins 612 are positioned within the slot 810, shown in FIG. 11, formed in the rotational bracket 802 and slide with respect thereto.

Accordingly, the rotational brackets 800 and 802 are coupled to the handle assembly 500 and the foot bracket assembly 600 to form a four-bar linkage with a locking member such that the foot bracket assembly 600 and the handle assembly 500 rotate with respect to the mast assembly 400. In one embodiment, rotation of one of the handle assembly or the foot bracket assembly results in the rotation of the other of the handle assembly and the foot bracket assembly. As illustrated in FIG. 11, the rotational bracket 802 includes the slot 810 to receive the pin 612. The slot 810 includes a locking slot 814 and an operational slot 812. The pin 612 may be moved between the operational slot 812 and the locking slot 814 when the device 100 is in the extended position, as illustrated in FIG. 1. When the pin 612 is retained within the locking slot 814, the device 100 is retained in the extended position. By manipulating the handle 502, the pin 612 may be moved into the operational slot 812, wherein the pin 612 can slide, so that the device 100 can move from the extended position, illustrated in FIG. 1, to the flexed position, illustrated in FIG. 2.

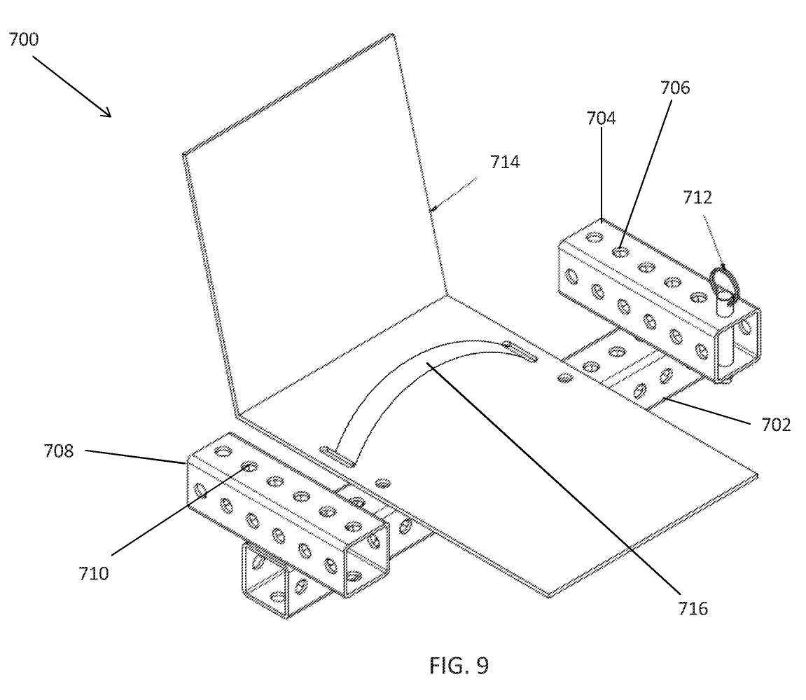

FIG. 9 illustrates a foot support assembly 700. The foot support assembly 700 includes a crossbar 702 having a first sleeve 704 coupled to a first end and a second sleeve 708 coupled to a second end. The first sleeve 704 and the second sleeve 708 are configured to be selectively positioned on the post 602 of the foot bracket assembly 600. For example, to arrange the device 100 for use with the right foot, the first sleeve 704 may be coupled to the post 602 of the foot bracket assembly 600.

The first sleeve 704 includes a plurality of openings 706. The first sleeve 704 may be adjustably coupled to the post 602 of the foot bracket assembly 600 to accommodate a size of the user. One of the openings 706 may be aligned with an opening 604 of the post 602 of the foot bracket assembly 600. A locking mechanism 712, for example a pin, may then be inserted through both the opening 706 and the opening 604 to retain the foot support assembly 700 on the post 602 of the foot bracket assembly 600 for use with the right foot. It will be appreciated that any locking mechanism may be utilized to retain the foot support assembly 700 on the post 602 of the foot bracket assembly 600.

The second sleeve 708 includes a plurality of openings 710. The second sleeve 708 may be adjustably coupled to the post 602 of the foot bracket assembly 600 to accommodate a size of the user. One of the openings 710 may be aligned with an opening 604 of the post 602 of the foot bracket assembly 600. The locking mechanism 712 may then be inserted through both the opening 710 and the opening 604 to retain the foot support assembly 700 on the post 602 of the foot bracket assembly 600 for use with the left foot, as illustrated in FIG. 13.

The foot support assembly 700 also includes a foot support 714 coupled to the crossbar 702. The foot support 714 provides a location for the user to place their foot during use of the device 100. The foot support 714 may include a strap 716 to retain the user's foot on the foot support 714.

Generally, the device 100 is configured so that the handle assembly 500 and the foot bracket assembly 600 are coupled to the mast assembly 400 during manufacturing to form a moving parts assembly. During operation, the base assembly 200 is rotated into the operational position by rotating the base mast 216 upward and locking the base mast 216 substantially perpendicular to the plate 202. The leg support assembly 300 is then coupled to the leg support base 208. The moving parts assembly is then coupled to the base mast 216 by sliding the mast assembly 400 onto base mast 216 and locking the mast assembly 400 to the base mast 216. The mast assembly 400 is secured to the base mast 216. The mast assembly 400 is also coupled to the base mast 216 at an appropriate height for the user's size.

The length of the handle assembly 500 may then be adjusted to an appropriate length for the user's size by telescopically moving the handle 502 within the outer post 504. The foot support assembly 700 is then coupled to the post 602 of the foot bracket assembly 600 by sliding the first sleeve 704 onto the post 602 of the foot bracket assembly 600. The distance of the foot support assembly 700 from the mast assembly 400 may be adjusted to accommodate the size of the user.

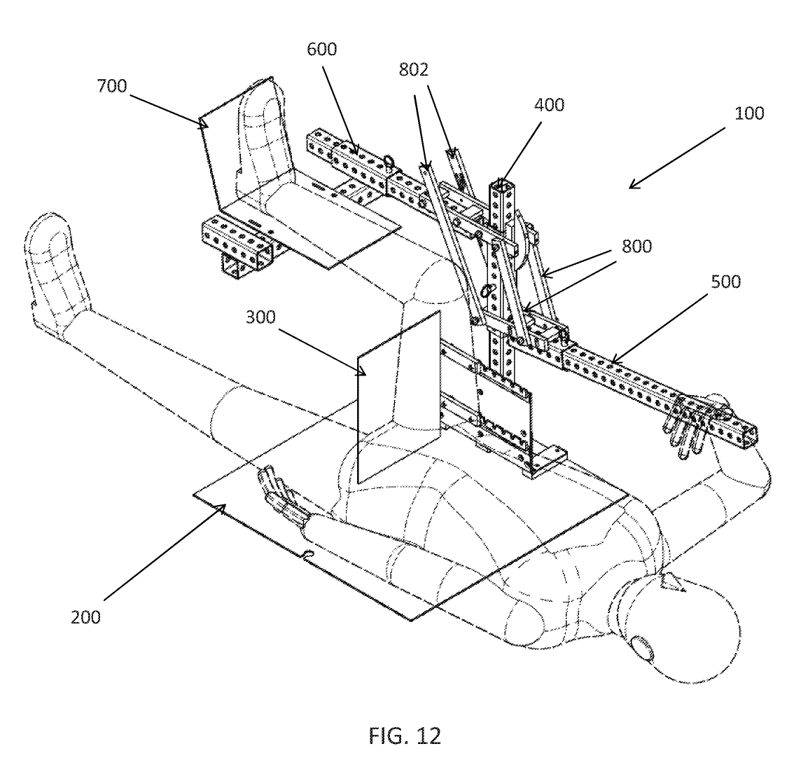

To operate the device, the user moves the handle assembly 500 until the device 100 is in the extended position, as illustrated in FIG. 1. In this position, the pins 612 of the bracket assembly 600 are positioned within the locking slots 814 of the rotational brackets 802. The user then lies on their back on the plate 202 with their buttocks and lower leg against the leg support 306. The user then places their foot on the foot support 714 and secures their foot thereto with the strap 716. FIG. 12 illustrates the device 100 having a user thereon. The user unlocks the handle assembly 500 by manipulating the handle 502 so that the pins 612 are moved into the operational slots 812 of the rotational brackets 802. The user may then flex or extend their knee by providing assistance with the handle 502 of the handle assembly 500.

For example, to flex the knee, the handle 502 may be pulled downward toward to user, thereby causing the foot support assembly 700 to move upward and move the leg into an extended position thus unlocking the device. The weight of the foot support assembly 700 then pulls the foot support assembly 700 downward to flex the knee. The user may control the amount of motion using the handle 502. The user may also track the amount of flexion on the scale 410.

To extend the knee, the user may first allow the foot support assembly 700 to drop to a downward position. Because the user's leg is secured to the foot support 714 via the strap 716, the user may extend their knee to raise the foot support assembly 700 upward. In one embodiment, the user may utilize the handle 502 to assist in extension by pulling the handle 502 downward.

After use, the foot support assembly 700 may be removed from the foot bracket assembly 600. The moving parts assembly, including the mast assembly 400, the handle assembly 500, and the foot bracket assembly 600 may be unitarily removed by disconnecting the mast assembly 400 from the base mast 216. In one embodiment, the handle 502 may also be removed from the outer post 504 of the handle assembly 500 to further accommodate storage. The leg support assembly 300 is then removed from the base assembly 200 so that the base assembly 200 may be transitioned into the storage position, as illustrated in FIG. 4. All of the components can then be stored together or individually.

In one embodiment, the device 100 may be arranged for use with the left foot, as illustrated in FIG. 13. It will be appreciated that the leg support assembly 300 may be rotated upside down to accommodate the left leg of a user. Additionally, by rotating the mast assembly 400 by 180° and coupling the second sleeve 708 of the foot support assembly 700 to the post 602 of the foot bracket assembly 600, the device 100 may be configured for a left leg.

While the embodiments have been illustrated and described in detail in the drawings and foregoing description, the same is to be considered as illustrative and not restrictive in character, it being understood that only certain embodiments have been shown and described and that all changes and modifications that come within the spirit of the embodiments are desired to be protected.

What is claimed is:

1. An orthopedic rehabilitation device comprising:
a base assembly;
a mast assembly extending from the base assembly;
a handle assembly rotatably coupled to the mast assembly;
a foot bracket assembly rotatably coupled to the mast assembly, wherein the foot bracket assembly is coupled to the handle assembly so that rotation of one of the handle assembly or the foot bracket assembly results in the rotation of the other of the handle assembly and the foot bracket assembly; and
a foot support assembly coupled to the foot bracket assembly so that the foot support assembly rotates with the foot bracket assembly.

2. The device of claim 1, wherein the base assembly further comprises a plate to support the device.

3. The device of claim 2, wherein the base assembly further comprises a leg support that is arranged substantially perpendicular to the plate.

4. The device of claim 3, wherein the base assembly further comprises a base mast extending substantially perpendicular from the plate, the mast assembly extending from the base mast, the leg support coupled to the base mast.

5. The device of claim 4, wherein the mast assembly is adjustably coupled to the base mast so that a height of the mast assembly may be adjusted.

6. The device of claim 1, wherein the mast assembly further comprises a scale indicating an angle between the foot bracket assembly and the mast assembly.

7. The device of claim 1, wherein the handle assembly further comprises an outer post and a handle, the handle being adjustably coupled to the outer post to adjust a length of the handle assembly.

8. The device of claim 7, wherein the handle assembly further comprises a handle assembly bracket coupled to the outer post, the handle assembly bracket rotatably coupled to the mast assembly.

9. The device of claim 1, wherein the foot bracket assembly further comprises a foot bracket assembly bracket rotatably coupled to the mast assembly.

10. The device of claim 1 further comprising at least one rotational bracket coupling the foot bracket assembly and the handle assembly so that rotation of one of the handle assembly or the foot bracket assembly results in the rotation of the other of the handle assembly and the foot bracket assembly.

11. The device of claim 10, wherein:
the handle assembly further comprises a handle assembly bracket rotatably couple to the mast assembly; and
the foot bracket assembly further comprises a foot bracket assembly bracket rotatably coupled to the mast assembly, wherein the at least one rotational bracket couples the handle assembly bracket and the foot bracket assembly bracket.

12. The device of claim 1, wherein the foot support assembly is adjustably coupled to the foot bracket assembly to adjust a position of the foot support assembly with respect to the mast assembly.

13. The device of claim 1, wherein the foot support assembly further comprises a foot support for placing a foot of a user.

14. The device of claim 13, wherein the foot support further comprises a strap to secure the foot of the user to the foot support.

15. An orthopedic rehabilitation device comprising:
a base assembly having a plate to support the device and a base mast extending substantially perpendicular from the plate;
a mast assembly adjustably extending from the base mast so that a height of the mast assembly may be adjusted;
a handle assembly rotatably coupled to the mast assembly proximate to the base assembly;
a foot bracket assembly rotatably coupled to the mast assembly distally from the base;
at least one rotational bracket coupling the foot bracket assembly and the handle assembly so that rotation of one of the handle assembly or the foot bracket assembly results in the rotation of the other of the handle assembly and the foot bracket assembly; and
a foot support assembly coupled to the foot bracket assembly so that the foot support assembly rotates with the foot bracket assembly, the foot support assembly including a foot support for placing a foot of a user.

16. The device of claim 15, wherein the base assembly further comprises a leg support coupled to the base mast and arranged substantially perpendicular to the plate.

17. The device of claim 15, wherein the handle assembly further comprises an outer post and a handle, the handle being adjustably coupled to the outer post to adjust a length of the handle assembly.

18. The device of claim 15, wherein the foot support assembly is adjustably coupled to the foot bracket assembly to adjust a position of the foot support assembly with respect to the mast assembly.

19. The device of claim 15, wherein the foot support further comprises a strap to secure the foot of the user to the foot support.

20. A method for constructing an orthopedic rehabilitation device, the method comprising:
extending a mast assembly from a base assembly;
rotatably coupling a handle assembly to the mast assembly;
rotatably coupling a foot bracket assembly to the mast assembly;
coupling the foot bracket assembly to the handle assembly so that rotation of one of the handle assembly or the foot bracket assembly results in the rotation of the other of the handle assembly and the foot bracket assembly; and
coupling a foot support assembly to the foot bracket assembly so that the foot support assembly rotates with the foot bracket assembly.
